(19) United States
(12) Patent Application Publication
(10) Pub. No.: US 2014/0202227 A1
(43) Pub. Date: Jul. 24, 2014

(54) User Calibratable Sensors

(71) Applicant: Maarten Van Laere, Heverlee (BE)

(72) Inventor: Maarten Van Laere, Heverlee (BE)

(21) Appl. No.: 14/159,432

(22) Filed: Jan. 20, 2014

Related U.S. Application Data
(60) Provisional application No. 61/754,805, filed on Jan. 21, 2013.

(51) Int. Cl. G01D 18/00

(52) U.S. Cl. CPC G01D 18/00
USPC 73/1.01

(57) ABSTRACT

An user calibratable environmental sensors for providing a solution for environmental monitoring sensors to be calibrated by users through a simple interface whereas previously such calibration, if possible depending on hardware, could only be achieved by doing it through a factory calibration requiring the user to send his sensors back to the manufacturer or to a calibration service provider. The user calibratable environmental sensors generally include a solution to solve the problem of environmental sensors that over time lose accuracy. In such cases typically calibration of the sensor probes is required. The invention solves this by enabling calibration within the logical unit controlling and/or communicating with the sensor probes. This allows a longer life time for sensor probes by enabling users to calibrate themselves their sensors if needed be.

### CROSS REFERENCE TO RELATED APPLICATIONS

This application claims priority from U.S. Patent Application Ser. No. 61/754,805, entitled “User Calibratable Sensors”, filed on 21 Jan. 2013. The benefit under 35 USC §119 of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention relates generally to sensor probe calibration. More specifically, the present invention relates to an apparatus and method for sensor probe calibration or re-calibration by owners or users of the probes after delivery from a manufacturer.

### BACKGROUND OF THE INVENTION

Sensor probes such as, but not limited to, temperature, humidity, airflow, flow, liquid levels, power, dry contact, shock, sound, gas probes are connected (either wired or wireless) to a logical unit. The logical unit makes the sensor probe values accessible to a user through communication protocols such as, but not limited to, TCP/IP, MODBUS or BACNET. Sensors may lose accuracy while in operation especially over time. The user of such sensor probes typically had two options: either to purchase new sensor probes or when possible return them for calibration (by factory or others). The present invention was made to enable users to calibrate, themselves, their sensor probes whenever there is a need to do such calibration.

### SUMMARY OF THE INVENTION

The invention generally relates to enabling users to perform themselves calibration or re-calibration of one or more sensor probes connected to a logical unit sensor, and as a result solve the problem of environmental sensors losing accuracy. This method allows a longer life time for sensor probes by enabling users to calibrate or re-calibrate their sensors themselves if needed be.

An objective of the present invention is to provide a solution for calibrating sensor probes through a simple interface whereas previously such calibration, if possible depending on hardware, could only be achieved by doing it through a factory calibration requiring the user to send his sensors back to the manufacturer or to a calibration service provider for calibration or re-calibration.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is an illustration of a logical unit and a sensor probe connected to it;

FIG. 2 is a flowchart illustrating the flow of how a user can calibrate the sensor probe through a GUI of the present invention;

FIG. 3 is a flowchart illustrating how the logical unit communicating with the sensor probe handles offset values of the present invention; and

FIG. 4 is a possible rendering of the calibration option in the GUI of logical unit controlling and/or communicating with sensor probes of the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

Now referring to the Figures, in which similar reference characters denote similar elements throughout the several views, the figures illustrate a solution to solve the problem of environmental sensors that over time lose accuracy. In such cases typically calibration of the sensor probes is required. The invention solves this by enabling calibration within the logical unit controlling and/or communicating with the sensor probes. This allows a longer life time for sensor probes by enabling users to calibrate themselves 9 their sensors if needed be.

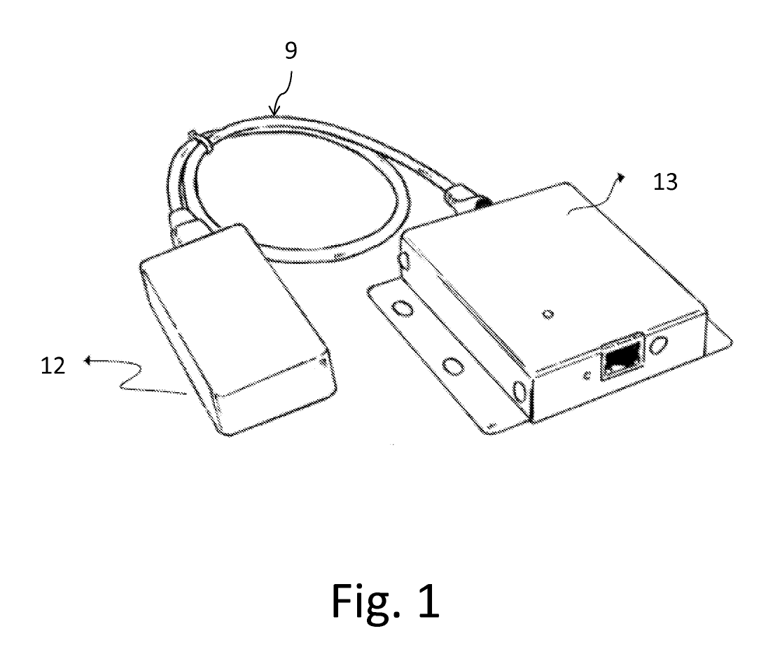

FIG. 1 is an illustration of a logical unit 133 and a sensor probe 12 connected to it. The logical unit 13 is a device controlling, communicating and/or managing sensor probes 12. The user communicates with the sensor probes 12 through the logical unit 13. The sensor probes 12 can be connected via a cable 9 to the logical unit 13, via a wireless connection, or can be mounted within the same enclosure as the logical unit 13. The latter two embodiments are not shown, but would be understood by a person of ordinary skill in the art from the provided figures and written explanation.

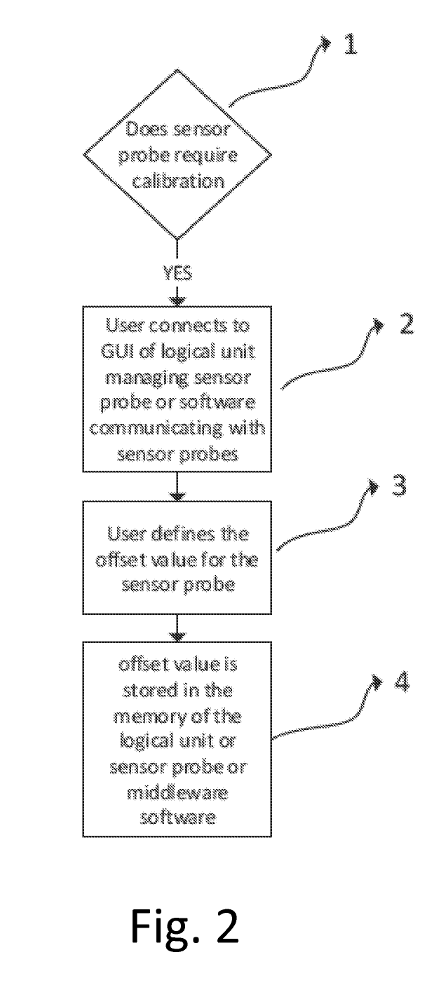

A graphical user interface 10 within the logical unit 13 controlling and/or communicating with the sensor probes 12 is displayed on a computer whereby a user can adjust sensor readings to correct the offset in readings 11 compared to a reference sensor probe. The flow of graphical user interface 10 is described in FIG. 2.

FIG. 2 is a flowchart illustrating how a user can calibrate the sensor probe 12 through a GUI 10. If the sensor probe 12 requires recalibration in step 1, then the user connects to the Graphical User Interface (GUI) 10 of the logic unit 13 managing sensor probe or software communicating with the sensor probe(s) 12 in step 2. In the graphical user interface 10, the user selects an option to calibrate the sensor probe 12 in step 3. The user then is directed to an interface in which he can define the offset value 11 for a sensor probe 12 in step 4. After changing the offset value 11 the change is saved (automatically or with user intervention) into the logical unit 13 controlling the sensor probe.

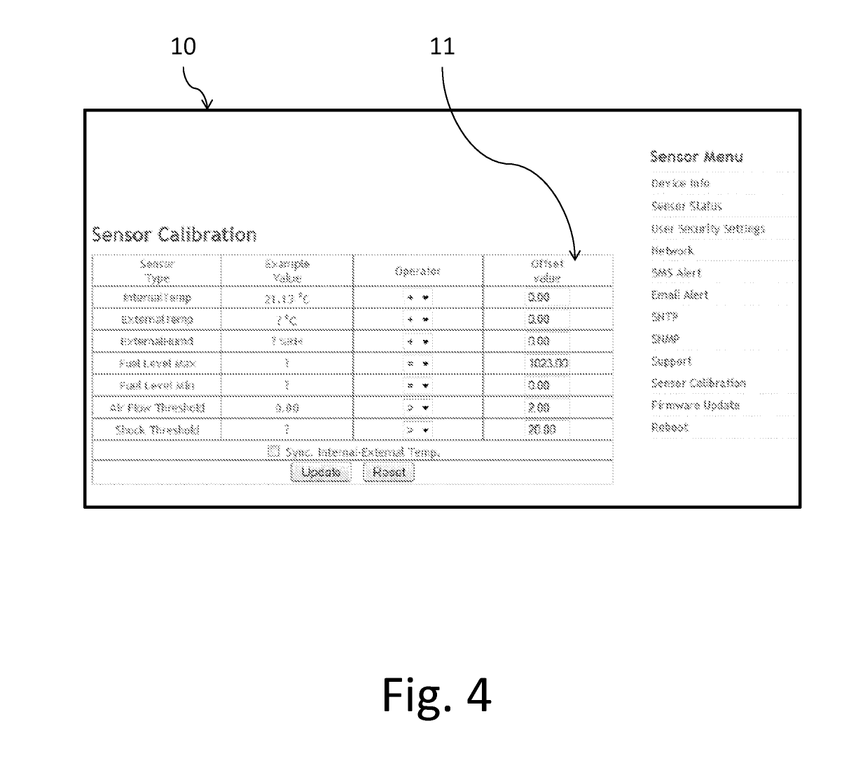

For the user interface as described in FIG. 2 and illustrated in FIG. 4, a GUI screen 10 is shown in which a user can set multiple items: a. The offset value 11 (single or multiple values) which is the value based with which the value obtained from a sensor probe reading should be corrected. Alternatively, the mathematical computation with which the value and offset value(s) 11 should be corrected in order to provide a calibrated sensor value result can also be determined by the computer running the software program which generates the GUI 10.

The items as described above can be included in a single or multiple screen embodiments. The mathematical computation, with which the returned value by the sensor probe should be adjusted based on the offset value 11, can either be provided by the user or can be calculated within the software program of the logical unit 13. For example a screen could request for a user to enter an offset value 11 (positive or negative) and automatically apply to that value a mathematical computation without requiring the user to specify it.

The GUI 10 can be used to calibrate one or multiple sensor probes 12 connected (wired or wireless) to a logical unit 13 which communicates and/or controls the sensor probes 12. FIG. 4 is a possible rendering of such a GUI 10.

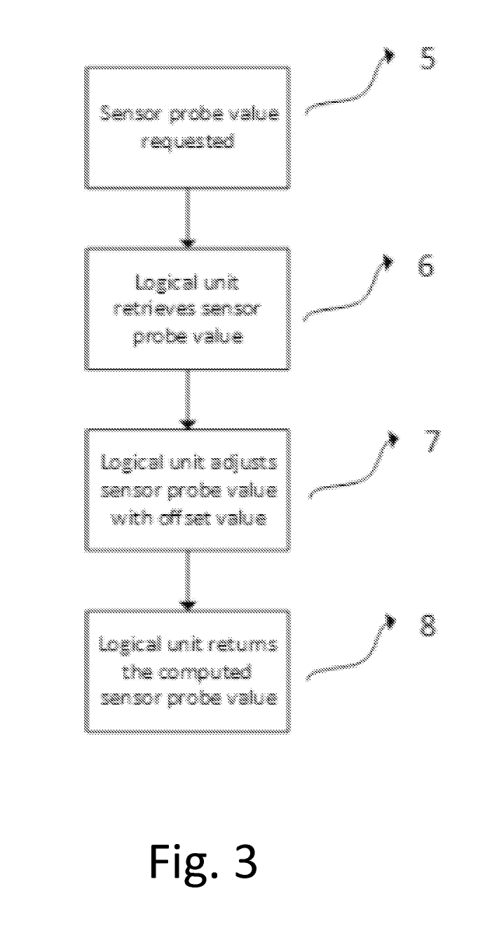

The GUI 10 as described in FIG. 2 can be generated by the logical unit 13 controlling and/or communicating with the sensor probes 12, or by a software application communicating either with the logical unit 13 controlling and/or communicating with the sensor probes 12 or with the sensor probes 12 directly.

Where logical units 1, controlling and/or communicating with sensor probes 12, typically only return the reading of the sensor probe value as acquired, the logical unit 13 in this case will adjust the reading of the sensor probe value with the calibration as defined by the user. The calculated new sensor probe value is returned by the logical unit 1 to the user. The flow of this main element is described in FIG. 3.

FIG. 3 is a flowchart illustrating how the logical unit 1 communicating with the sensor probe 12 handles offset values 11. When a sensor probe value is requested by a user (human or machine) in step 5, then the logical unit 13 retrieves the value from sensor probe 12 in step 6. The logical unit 13 then adjusts the sensor probe value with the offset value 11 as defined by the user in step 7. Finally, the logical unit 13 returns the new computed sensor probe value to the user (human or program) in step 8.

In the above flowchart the retrieval of a value from a sensor probe 12 by the logical processing unit 13 can be in any order. The value from the sensor probe 2 as in step 6 can either be retrieved from a memory or through direct communication with the sensor probe 12 depending on the architecture of the logical unit 1 controlling or communicating with the sensor probes 12.

Environmental sensors are queried for their values typically in two ways: either by human request through a user interface or by computer programs. When a request is received by the logical unit 13 controlling and/or communicating with the sensor probes 12, the logical unit 13 will correct the value reading received by the sensor probe 12 based on the offset value defined in the GUI 10 and a mathematical computation as described in the method illustrated in FIG. 2.

The logical unit 13 controlling and/or communicating with the sensor probes 12, may return not only the correct value based on the calibration settings done described in the method illustrated in FIG. 2, the logical unit 13 controlling and/or communicating with the sensor probes 12 may also return the value of the sensor probe 12 without the calibration applied to it. The process, as described in FIG. 3, can be done sequentially or in parallel for multiple sensor probes value requests.

The user calibration of a sensor probe 12 through an interface 13 as described previously is linked to the process which returns the sensor probe value when requested by a user (human or computer). The sensor probe value(s) can reside within the same logical unit 13 where the calibration values are stored in memory (permanent or volatile). The two different actions as described in FIG. 2 and FIG. 3 can be part of the same software program or different software programs running on the logical unit 13 which communicates and/or controls the sensor probes 12.

Sensor probes 12 can be any type of sensor such as, but limited to, temperature, humidity, airflow, power failure, power metering, sound, light, liquids, shock, dry contacts. Such sensor probes are connected in either a wired or wireless way with a logical unit. The logical unit 13 of the present invention enables users amongst one of many possible functions to retrieve values from the sensor probes 12.

If the user of sensor probes has a sensor probe 12 which is out of range or requires calibration for any given reason, then the user can connect to an interface rendered by the logical unit 13 or a software capable of communicating with the sensor probes 12 requiring calibration. In that GUI 10 the user sets the offset value 11 for the sensor probe(s) 2. The same interface (in the same or a different screen) may also give the option to set the mathematical computation method (subtracting, adding, dividing, multiplying or any combination thereof) required to obtain a new calibrated and as accurate as possible sensor reading. The logical unit then saves (automatically or by user intervention) the data submitted by the user required for calibration.

A user can request a sensor probe value from the logical unit 13 communicating with the sensor probes 12 either through an interface or through machine to machine communication. When a user requests a sensor probe reading for which a calibration was defined then the logical unit 13 will first retrieve the value from the sensor probe 12 (either directly from the probe or from its memory) per step 6 and adjust the value with the offset value 11 and mathematical operation per step 7. The logical unit 13 will then return the computed (calibrated) sensor probe value per step 8.

FIG. 4 is a possible rendering of the calibration option in the GUI 10 of logical unit 13 controlling and/or communicating with sensor probes of the present invention. The image in FIG. 4 illustrates how such calibration can work in a logical unit 13 communicating and/or controlling sensor probes 12. In this example calibration settings are available for a temperature sensor probe, humidity sensor probe, fuel level sensor probe, airflow probe and a shock sensor probe.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. An apparatus for sensor probe calibration comprising:
a logical unit;
one or more sensor probes;
the logical unit and sensor probes connected;
the logical unit controls, communicates, and / or manages the sensor probes;
the logical unit contains non-transitory software for execution on a computer; and
the software generates a graphical user interface on a computer whereby sensor readings can be adjusted to correct the offset in readings compared to a reference sensor probe.

2. The apparatus of claim 1, wherein the logical unit and sensor probe are connected via a cable.

3. The apparatus of claim 1, wherein the logical unit and sensor probe are connected by a wireless connection.

4. The apparatus of claim 1, wherein the logical unit and sensor probe are mounted within the same enclosure.

5. The apparatus of claim 1, wherein
the logical unit, controlling and/or communicating with sensor probes, only return the reading of the sensor probe value as acquired;
the logical unit adjusts the reading of the sensor probe value with a pre-defined calibration provided by a user; and
the calculated new sensor probe value is returned by the logical unit to the user.

6. A method for sensor probe calibration comprising:
connecting a logic unit to one or more sensor probes;
selecting an option to calibrate the sensor probes;
defining an offset value for each selected sensor probe;
changing the offset value;
saving into the logical unit controlling the sensor probe;

7. The method of claim 6, wherein the changed offset value is saved into the logical unit controlling the sensor probe automatically.

8. The method of claim 6, wherein the changed offset value is saved into the logical unit controlling the sensor probe manually.

9. The method of claim 6, further comprising the step of displaying a GUI screen for setting multiple items.

10. The method of claim 6, wherein the offset value is the value based on with which the value obtained from a sensor probe reading should be corrected.

11. The method of claim 10, further comprising the step of incorporating a mathematical computation with which the value and offset value(s) should be corrected in order to provide a calibrated sensor value result can also be determined by the computer running the software program which generates the GUI.

12. The method of claim 11, wherein the mathematical computation, with which the returned value by the sensor probe, is adjusted based on the offset value, can either be provided by or calculated by the logical unit.

13. The method of claim 6, wherein the GUI can be used to calibrate one or multiple sensor probes connected to a logical unit which communicates and/or controls the sensor probes

14. The method of claim 6, wherein the logical unit and sensor probe are connected via a cable.

15. The method of claim 6, wherein the logical unit and sensor probe are connected by a wireless connection.

16. The method of claim 6, wherein the GUI can be generated by the logical unit controlling and/or communicating with the sensor probes, or by a software application communicating either with the logical unit controlling and/or communicating with the sensor probes or with the sensor probes directly.

17. The method of claim 6, further comprising the steps of:
requesting a sensor probe value;
retrieving the value from sensor probe by the logical unit;
adjusting the sensor probe value with the offset value by the logical unit as defined by a user; and
returning the new computed sensor probe value to the user by the logical unit.

18. The method of claim 17, wherein the value from the sensor probe can either be retrieved from a memory or through direct communication with the sensor probe depending on the architecture of the logical unit controlling or communicating with the sensor probes.

19. The method of claim 17, wherein environmental sensors are queried for their values typically in two ways: either by human request through a user interface or by computer programs.

20. The method of claim 19, wherein when a request is received by the logical unit controlling and/or communicating with the sensor probes, the logical unit will correct the value reading received by the sensor probe based on the offset value defined in the GUI and a mathematical computation.
